(19) United States
(12) Patent Application Publication
(10) Pub. No.: US 2004/0000142 A1
(43) Pub. Date: Jan. 1, 2004

(54) High-pressure and low-pressure selecting valve and swash-plate type hydraulic motor system

(76) Inventor: Hirotaka Nunomura, Toyama-shi (JP)

Correspondence Address: Venable, P.O. Box 34385, Washington, DC, 20043-9998, US

(21) Appl. No.: 10/180,330

(22) Filed: Jun. 27, 2002

(51) Int. Cl. F16D 31/02

(52) U.S. Cl. 60/445

(57) ABSTRACT

A high-pressure and low-pressure selecting valve includes a valve body and a valve member movably provided in the valve body. The valve body has a pair of input ports, at least one output port, and a low-pressure port. The input ports, the output port, and the low-pressure port are so formed that when input to one of the input ports is of a higher hydraulic pressure, the valve member is moved by the pressure to connect the one input port to one of the output ports and the other input port to the low-pressure port. A swash-plate type hydraulic motor system selects, by means of this valve, high-pressure liquid necessary for controlling the swash plate and simultaneously connects the low-pressure relief valve to the low-pressure side of the system.

### BACKGROUND OF THE INVENTION

The present invention relates to a high-pressure and low-pressure selecting valve for switching an output port to another in accordance with an input hydraulic pressure. This selecting valve is suitable, but not exclusively, for use in a swash-plate type variable speed hydraulic motor system, and the invention also relates to such a system.

It is known that, in a closed circuit including a hydraulic motor used in construction machines and the like, a flushing valve combining a low-pressure selecting valve and a low-pressure relief valve is provided to draw out the working liquid from the low-pressure side of the circuit and clean it.

Also, when a swash-plate type variable speed motor is used as a hydraulic motor, hydraulic pressure is introduced into an actuator for controlling a swash plate to vary an inclination of the swash plate thereby changing a speed of the motor. Therefore, it is necessary to provide a separate selecting valve to select the high-pressure side liquid in the circuit. Such a high-pressure selecting valve is disclosed in, for example, JP-A-08-210243, JP-A-09-188280, and U.S. Pat. No. 6,336,323.

This high-pressure selecting valve may be used in combination with the above-mentioned flushing valve. Such a combined hydraulic circuit is shown in a leaflet entitled “TITAN TH Series” issued by Teijin Seiki Co., Ltd., Tokyo, Japan.

The combination of the above-mentioned high-pressure selecting valve and a flushing valve is advantageous in increasing operational reliability of a hydraulic motor system, but that has a problem in that the number of parts increases thereby requiring more work in machining of the components.

### BRIEF SUMMARY OF THE INVENTION

The present invention has an object of providing a selecting valve which fulfills both functions of high-pressure selection and low-pressure selection while having parts of a less number.

It is another object of the invention to provide a swash-plate type variable speed hydraulic motor system of high reliability and a low cost.

To these ends, according to the invention, a low-pressure selecting valve is provided with a flow path for high-pressure output so that the flow path is connected to the high-pressure side of the input ports with the valve member moving for low-pressure selection. This arrangement makes it possible to simultaneously select high-pressure and low-pressure with a single valve.

By applying this high-pressure and low-pressure selecting valve to a swash-plate type hydraulic motor system, it is made possible by using one valve to simultaneously perform the selection of high-pressure for changing the speed of the hydraulic motor, and the selection of low pressure for a low-pressure relief. In this way, a swash-plate type hydraulic motor system, which has a less number of parts compared with the combination system of a high-pressure selecting valve and a flushing valve according to the prior art and even provides a high degree of operational reliability, is realized.

The high-pressure and low-pressure selecting valve of the invention includes a valve body, a valve member movably provided in the valve body, and a pair of input ports, at least one output port, and a low-pressure port provided in the valve body. The input ports, the output port, and the low-pressure port are so formed and arranged that when input to one of the input ports is of a higher hydraulic pressure, the valve member is moved by the pressure thereby connecting the one input port to the output port and the other input port to the low-pressure port.

Further, the hydraulic motor system of the invention has a hydraulic motor, the above-described high-pressure and low-pressure selecting valve, an actuator-switching valve, and a low-pressure relief valve. The hydraulic motor has a rotary shaft, a rotor coupled through splines to the rotary shaft for rotation therewith and having a plurality of sets of cylinders and pistons, a pair of feed/discharge paths which successively come into communication with the cylinders as the rotor rotates, a swash plate slidably abutting on the ends of the pistons for converting the movement of the pistons into the rotation of the rotor, which is provided for changing of its inclination so that the stroke of the piston movement is varied to change the rotational speed of the rotary shaft, and a hydraulic actuator for changing the inclination of the swash plate. The actuator-switching valve controls the supply of a pressurized liquid to the actuator of the hydraulic motor. The low-pressure relief valve controls the pressure of the liquid returning from the cylinders of the hydraulic motor. One of the input ports of the above-mentioned selecting valve is connected to one of the feed/discharge path pair of the hydraulic motor, and the other input port to the other of the feed/discharge path pair. The output port of the selecting valve is connected to the input side of the actuator-switching valve, and the low-pressure port of the selecting valve is connected to the low-pressure relief valve. When the pressurized liquid is introduced into either of the input ports, the selecting valve introduces the pressurized liquid into the actuator-switching valve through the output port of the selecting valve and connects the liquid return side of the hydraulic motor to the low-pressure relief valve through the low-pressure port of the selecting valve.

### BRIEF DESCRIPTION OF THE SEVERAL VIEWS OF THE DRAWING

Other objects, features and advantages of the invention will become apparent from the following description of embodiments of the invention taken in conjunction with the accompanying drawings, in which:

FIG. 1 is a sectional view schematically showing a high-pressure and low-pressure selecting valve according to an embodiment of the invention;

FIG. 2 is a sectional view showing a swash-plate type dual speed hydraulic motor system according to another embodiment of the invention, in which the selecting valve of FIG. 1 is incorporated;

FIG. 3 is a sectional view showing a valve unit of the system of FIG. 2; and

FIGS. 4A to 4C are hydraulic circuit diagrams showing different operational states of the system of FIG. 2.

### DETAILED DESCRIPTION OF THE INVENTION

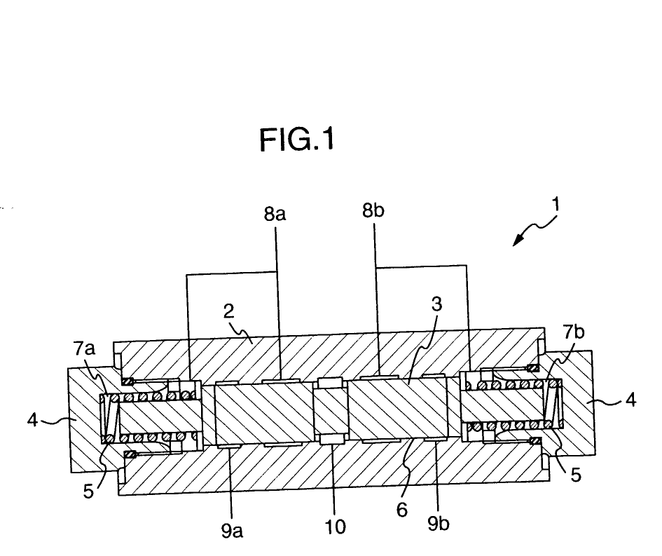

Referring to FIG. 1, a high-pressure and low-pressure selecting valve 1 according to the embodiment of the invention comprises a valve body 2, a shuttle spool 3 serving as a valve member, a pair of end covers 4, and a pair of coil springs 5.

The valve body 2 has an elongate bore 6 of a circular cross section formed within the body. At the opposite ends of the valve body 2, the end covers 4 are threadedly installed respectively. The end covers 4 each have a substantially cup-like shape, close the bore 6 of the valve body and define first and second spring chambers 7a and 7b at the opposite ends of the valve body.

The shuttle spool 3 is generally in an elongate cylindrical shape and is formed with a pair of land portions on both sides of the center of its length. The shuttle spool 3 is slidably accommodated in the bore 6 of the valve body. The coil springs 5 are disposed in the first and second spring chambers 7a and 7b respectively and press the both ends of the shuttle spool 3 in opposing directions. The pressing forces of these coil springs 5 rival or stand against each other thereby holding the shuttle spool 3 at its neutral position.

The valve body 2 is provided with first and second input ports 8a and 8b, first and second output ports 9a and 9b, and a low-pressure port 10. The bore 6 of the valve body is formed with inner peripheral grooves in communication with these ports, respectively. In the case of this embodiment, a low-pressure groove in communication with the low-pressure port 10 is located at the middle of the length of the valve body, likewise input grooves in communication with the input ports 8a and 8b are located on both sides of the low-pressure groove, and output grooves in communication with the output ports 9a and 9b respectively are located on both sides of those input grooves and adjacent to the spring chambers 7a and 7b. The first and second input ports 8a and 8b further communicate with the first and second spring chambers 7a and 7b, respectively.

The sizes and locations of the input, output, and low-pressure grooves of the valve body 2, the land portions of the shuttle spool 3 and the clearance between the bore 6 and the spool 3 are arranged as follows.

(1) When the shuttle spool 3 travels a predetermined distance away from one of the input grooves, one output groove on the backward side with respect to the moving direction is brought into communication with the adjacent spring chamber, and the other output groove on the forward side is brought into communication with the low-pressure groove.

(2) When the first and second input grooves are filled with liquid of the same pressure, the first and second output grooves are also subject to same pressure with each other.

Therefore, for example, when the input to the first port 8a is of a high hydraulic pressure, the pressure is applied to the first spring chamber 7a thereby pressing the shuttle spool 3 and moving it rightward in FIG. 1. When the shuttle spool 3 travels a predetermined distance, the peripheral groove corresponding to the first output port 9a is brought into communication with the first spring chamber 7a. As a result, the high-pressure liquid in the first input port 8a flows into the first output port 9a through the first spring chamber 7a. At the same time, the second input port 8b on the low-pressure side is brought into communication with the low-pressure port 10 through the communication of the corresponding peripheral groove. Thus, high-pressure input and low-pressure input at the first and second ports 8a and 8b are selected and outputted to corresponding ports respectively.

On the other hand, when the liquid inputted to the second input port 8b has a higher pressure, the travel of the shuttle spool 3 in the opposite direction to that described above makes the input port 8b communicate with the second output port 9b and the first input port 8a with the low-pressure port 10.

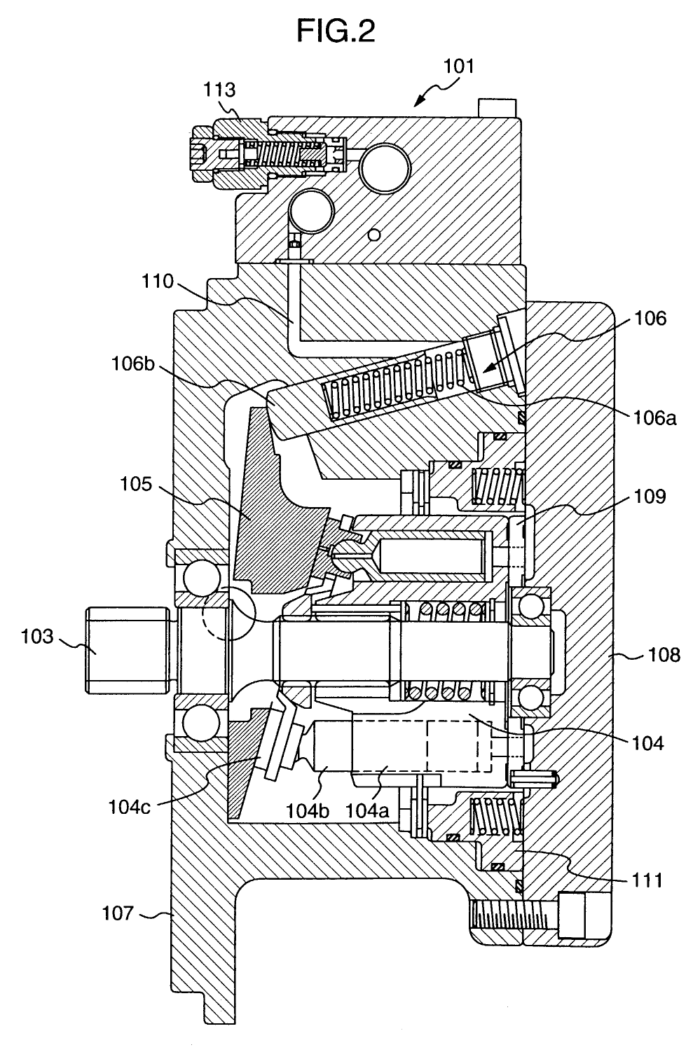

Next, the swash-plate type hydraulic motor of the invention will be described. The embodiment shown in FIG. 2 to FIGS. 4A to 4C is a swash-plate type dual speed hydraulic motor system in which the high-pressure and low-pressure selecting valve shown in FIG. 1 is included.

This system is comprised of a valve unit 101 and a hydraulic motor 102. The valve unit 101 includes the high-pressure and low-pressure selecting valve 1 of FIG. 1 and other valves for controlling the hydraulic motor, which will be described later. The valve unit 101 is assembled to the hydraulic motor 102 with flow paths for these valves aligned with corresponding flow paths provided in the hydraulic motor 102.

The hydraulic motor 102 has, as shown in FIG. 2, a rotary shaft 103, a rotor 104 which is connected with the shaft through splines so as to rotate together, a swash plate 105 inclined for changing the speed of the rotary shaft, an actuator 106 for controlling the inclination of the swash plate, and front and rear casings 107, 108 for housing the foregoing components. The rotary shaft 103 is rotatably supported by bearings provided in the front and rear casings 107, 108.

The rotor 104 has a plurality of cylinders 104a formed surrounding the rotary shaft 103 and feed/discharge paths formed in the rear surface (the right side in the figure) of the rotor and in communication with each of the cylinders. A piston 104b is slidably disposed in each cylinder 104a extending along the rotary shaft 103. The end of each piston 104b protrudes forwardly from the associated cylinder 104a.

A switching-valve plate 109 is provided in slidable abutment against the rear surface of the rotor 104. The switching-valve plate has a series of feed/discharge openings which are perforated so as to come into communication with the cylinder feed/discharge paths as the rotor rotates. These feed/discharge openings communicate with the above-described valve unit 101 through flow paths provided in the casings 107 and 108.

On one hand, the swash plate 105 is pivotably mounted at the front side of the rotor 104. The swash plate 105 has a flat surface on the side that faces the rotor 104, and the front ends of the rotor pistons 104b slidably abut against the flat surface through a shoe 104c.

The actuator 106 for controlling the swash plate has a cylinder 106a formed in the front casing 107 and a piston 106b slidably disposed in the cylinder. The cylinder 106a communicates with the valve unit 101 through a flow path 110 in the front casing 107. The front end of the piston 106b protrudes from the cylinder 106a and abuts against the upper end of the swash plate 105. The piston 106 presses the swash plate 105 to change its inclination by means of the hydraulic pressure introduced into the cylinder 106a.

The hydraulic motor 102 is further provided with a hydraulic brake system 111.

The structure of the hydraulic motor 102 itself may be similar to a conventional one and therefore, for simplification, further description on the components and operations of the hydraulic motor will be omitted. A conventional hydraulic motor of this kind is disclosed in, for instance, U.S. Pat. No. 6,336,323, which has been referred to hereinabove, and the disclosure thereof is incorporated herein by reference.

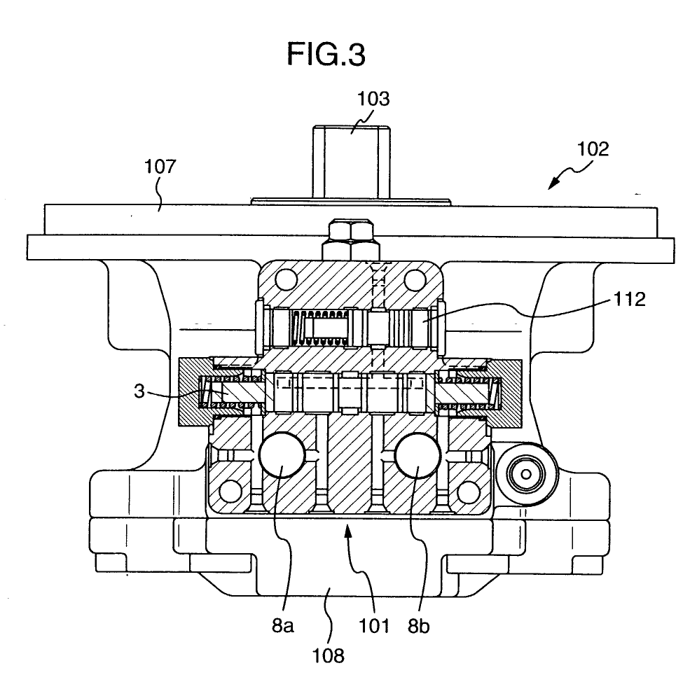

Referring to FIG. 3, the valve unit 101 has the above-described high-pressure and low-pressure selecting valve 1, and a switching valve 112 for the swash plate control actuator. In addition, a low-pressure relief valve 113 is also incorporated (see FIG. 2).

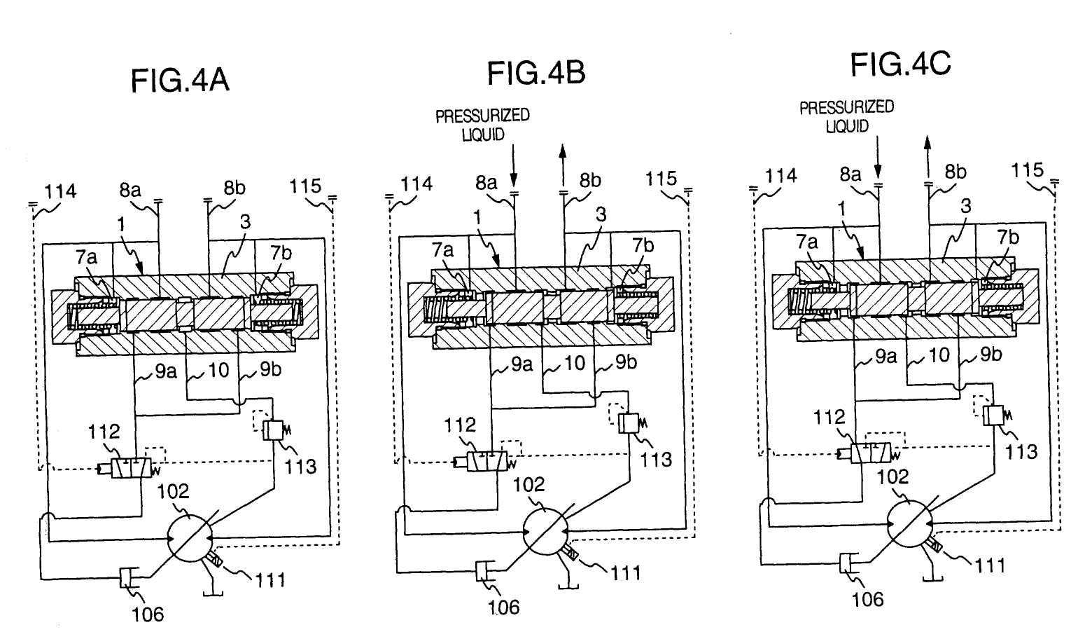

FIGS. 4A to 4C show the hydraulic circuit of the entire system. As apparent from these figures, the hydraulic motor 102 is connected, for control of its operation, with the high-pressure and low-pressure selecting valve 1, the actuator-switching valve 112, and the low-pressure relief valve 113 through flow paths.

Regarding the selecting valve 1, the first input port 8a is connected to ones of the feed/discharge openings of the switching valve plate 109 (FIG. 2), and the second input port 8b is connected to the other feed/discharge openings. Further, both of the first and second output ports 9a and 9b communicate with the input side of the actuator-switching valve 112, and the output side of the switching valve 112 communicates with the actuator 106 for controlling the swash plate.

The actuator-switching valve 112 is of the type in which the spool is switched by means of a pilot pressure for control, and is adapted to have a pressurized liquid for changing the motor speed through the port 114.

On one hand, the low-pressure port 10 of the selecting valve 1 is connected with the hydraulic motor 102 thorough the low-pressure relief valve 113. The relief valve is adapted to be opened by the liquid pressure when the liquid pressure at the low-pressure port 10 is equal to or exceeds a predetermined value.

Furthermore, the brake device 111 of the hydraulic motor 102 is in communication with a port 115 for introducing a pressurized liquid for control.

Subsequently, the operation of this system will be described. FIG. 4A shows a state in which no pressurized liquid is introduced in either of the input ports 8a and 8b of the selecting valve 1 or a liquid of same pressure is introduced in these ports. In this case, the shuttle spool 3 is at its neutral position, and the output ports 9a and 9b and the low-pressure port 10 are not in communication with either of the input ports 8a and 8b. The hydraulic motor 102 is in a standstill state with its pistons 104b being out of operation.

As shown in FIG. 4B, when a high-pressure liquid is introduced into the input port 8a, this liquid flows into some cylinders 104a through feed/discharge openings of the switching valve plate 109 (FIG. 2) and moves the pistons 104b thereby rotating the rotor 104 and the rotary shaft 103. As the rotor 104 rotates, the liquid which drove the pistons 104b reduces in pressure and flows out of the cylinders 104a returning to the input port 8b side.

At the same time, the high hydraulic pressure enters into the first spring chamber 7a of the selecting valve 1 and presses the shuttle spool 3 to move it rightward in the figure. As a result, the first output port 9a is brought into communication with the input port 8a through the spring chamber 7a, and likewise the low-pressure port 10 with the second input port 8b. This makes the high-pressure liquid in the input port 8a enter into the actuator-switching valve 112, allowing it to drive the actuator 106 in accordance with the operation of the switching valve 112.

On one hand, part of the liquid which returned to the input port 8b side passes through the low-pressure port 10 of the selecting valve to the low-pressure relief valve 113. At this moment, if the pressure of the low-pressure liquid is equal to or higher than a predetermined value, the relief valve 113 is opened and the liquid in the circuit is drawn out through a drain port (not shown) of the hydraulic motor 102.

Incidentally, this closed circuit incorporating the hydraulic motor is provided with a pump for refilling a new or cleaned working liquid in accordance with the above-described drawing out of the low-pressure side liquid.

FIG. 4C shows a state in which the controlling liquid has entered into the actuator-switching valve 112 from the port 114 thereby having the spool switched in the mode shown in FIG. 4B. As a result, the pressurized liquid enters into the actuator 106 and drives it thereby changing the inclination of the swash plate 105. This causes the traveling stroke of the pistons 104b to be changed thereby changing the rotational speed of the rotor 104 and the shaft 103.

Contrary to this, when the input to the second port 8b is of a higher pressure, the operation of the system is reversed from the state shown in FIGS. 4B and 4C in such a way that the hydraulic motor 102 rotates in the opposite direction.

The port 115 of the system, when desired, is supplied with liquid pressure to release the braking device 111 of the hydraulic motor to enable the rotation of the hydraulic motor.

As described so far, the selecting valve of the present invention can fulfill both functions of high-pressure selection and low-pressure selection by means of a single valve structure. Further, the swash-plate type hydraulic motor system including the foregoing high-pressure and low-pressure selecting valve has a less number of parts, therefore a low cost and high operational reliability.

Although the foregoing description has been made on the embodiments of the invention, it will be understood by those skilled in the art that the invention is not limited solely to the specific forms, and that various changes and modifications may be made in the invention without departing from the spirit of the invention and the scope of the appended claims.

1. A high-pressure and low-pressure selecting valve comprising:
a valve body;
a valve member movably provided in said valve body; and
a pair of input ports, at least one output port and a low-pressure port provided in said valve body, said input ports, said output port and said low-pressure port being so formed and arranged that, when input to one of said input ports is of a higher hydraulic pressure, said valve member is moved by the pressure to connect said one input port to said output port and the other input port to said low-pressure port.

2. The selecting valve according to claim 1, further comprising springs which press both ends of said valve member in opposite directions respectively so that said valve member is held at a neutral position where said input ports, said output port, and said low-pressure port are not in communication with one another.

3. The selecting valve according to claim 1, wherein said valve body defines a bore of a circular cross section therein, and said valve member comprises a shuttle spool slidable in the bore.

4. The selecting valve according to claim 1, further comprising a pair of springs which press both ends of said valve member in opposite directions so as to hold said valve member at a neutral position, and a pair of spring chambers for accommodating said springs, wherein each of said input ports is in communication with adjacent one of said spring chambers, and said output port comes into communication with one of said spring chambers in accordance with movement of said valve member.

5. A hydraulic motor system, comprising:
a hydraulic motor including a rotary shaft, a rotor having a plurality of sets of cylinders and pistons and coupled through splines to said rotary shaft for rotation therewith, a pair of feed/discharge paths successively coming into communication with said cylinders as said rotor rotates, a swash plate slidably abutting on ends of said pistons for converting movement of said pistons into rotation of said rotor, said swash plate being provided to be changeable of its inclination so that a stroke of the piston movement is varied to change a rotational speed of said rotating shaft, and a hydraulic actuator for changing the inclination of said swash plate;
a high-pressure and low-pressure selecting valve including a valve body, a valve member movably provided in said valve body, and a pair of input ports, at least one output port and a low-pressure port provided in said valve body, said input ports, said output port and said low-pressure port being so formed and arranged that, when input to one of said input ports is of a higher hydraulic pressure, said valve member is moved by the pressure to connect said one input port to said output port and the other input port to said low-pressure port;
an actuator-switching valve for controlling supply of a pressurized liquid to said actuator of said hydraulic motor;
a low-pressure relief valve for controlling pressure of the liquid returning from said cylinders of said hydraulic motor; and
one of said input ports of said selecting valve being connected to ones of said feed/discharge path pair of said hydraulic motor, the other input port being connected to the other feed/discharge paths, and said output port of said selecting valve being connected to an input side of said actuator-switching valve, so that when a pressurized liquid is introduced to either of said input ports of said selecting valve, the pressurized liquid is introduced into said actuator-switching valve through said output port of said selecting valve and a liquid return side of said hydraulic motor is connected to said low-pressure relief valve though said low-pressure port of said selecting valve.
